(19) United States
(12) Patent Application Publication
(10) Pub. No.: US 2014/0284369 A1
(43) Pub. Date: Sep. 25, 2014

(54) STAPLE-EJECTING TYPE STAPLER

(71) Applicant: GuangZhou PanYu Tung Yung Stationery MFY., LTD., Guangzhou (CN)

(72) Inventors: Xiaorong Yang, Guangzhou (CN); Zhongmin Duan, Guangzhou (CN); Changhai Dai, Guangzhou (CN)

(73) Assignee: GuangZhou PanYu Tung Yung Stationery MFY., LTD., GuangZhou (CN)

(21) Appl. No.: 14/093,534

(22) Filed: Dec. 2, 2013

(30) Foreign Application Priority Data
Mar. 22, 2013 (CN) 201310095203.9

(51) Int. Cl. B25C 5/11; B25C 5/02

(52) U.S. Cl. CPC B25C 5/11; B25C 5/0285
USPC 227/132

(57) ABSTRACT

An embodiment of the present application provides a staple-ejecting type stapler, which can use an energy storing and energy releasing assembly to store energy by means of the lever principle and to generate an elastic force by releasing the elastic potential energy. Under the action of the elastic force, a staple driver pushes a staple to pierce through paper, and legs of the staple are bent by an anvil plate, thereby realizing the binding function in a convenient and labor-saving manner.

The present application claims the benefit of priority to Chinese patent application No. 201310095203.9 titled “STAPLE-EJECTING TYPE STAPLER” filed with the Chinese State Intellectual Property Office on Mar. 22, 2013. The entire disclosure thereof is incorporated herein by reference.

### TECHNICAL FIELD

The present application relates to the technical field of staplers, and in particular to a staple-ejecting type stapler.

### BACKGROUND

Stapler is a tool for binding documents or paper and has been widely used in offices.

A conventional stapler generally consists of a cover, a staple driver, a staple magazine, a staple pusher, an anvil, a base, and etc. In using, a pressure is applied on the cover and is transmitted to the staple driver via the cover. Then, a staple is pressed by the staple driver to pierce through a paper, and legs of the staple are bent by an anvil plate, thereby realizing the binding function of the stapler.

However, since in the conventional stapler, the staple is directly driven by human power via the staple driver to pierce through the paper and to be bent, a user has to apply a large pressure on a normal stapler during binding, which may cause inconvenience in using.

### SUMMARY

embodiment of the present application provides a staple-ejecting type stapler, which can use an energy storing and energy releasing assembly to store energy by means of the lever principle and to generate an elastic force by releasing the elastic potential energy. Under the action of the elastic force, a staple driver pushes a staple to pierce through paper, and legs of the staple are bent by an anvil plate, thereby realizing the binding function in a convenient and labor-saving manner.

The staple-ejecting type stapler according to the embodiment of the present application includes a top plate, a main body and a base, wherein

the top plate is movably connected to the main body via a rotating shaft and configured to provide pressure for the main body;

the main body has two ends, respectively, movably connected to the top plate and the base via a rotating shaft;

the base is configured to support the main body and bend legs of a staple;

wherein the main body includes an energy storing and energy releasing assembly, a staple magazine assembly and a staple pusher assembly, the energy storing and energy releasing assembly is arranged in the main body and is connected to the top plate, and is configured to store and release an elastic potential energy, the staple magazine assembly is configured to receive staples, and the staple pusher assembly is configured to push the staples; and

the base includes a bottom plate, and an anvil plate fixed on the bottom plate and arranged opposite to a staple outlet.

Optionally, the energy storing and energy releasing assembly includes a staple driver, a shift lever, a reset torsion spring and an leaf spring;

the staple driver is arranged in a guiding groove which is arranged in the main body and is perpendicular to the main body, and the staple driver has an upper portion provided with a small hole for cooperating with one end of the shift lever and a middle portion provided with a small hole for cooperating with the leaf spring;

the shift lever is movably arranged inside the main body via a rotating shaft, and is provided with a small hole for cooperating with the rotating shaft and having an area lager than a cross-sectional area of the rotating shaft;

the reset torsion spring has one end connected to one end of the shift lever and the top plate, and the other end connected to the main body; and

the leaf spring has one end connected to the staple driver and the other end fixed on the main body.

Optionally, the staple magazine assembly includes a main body left plate, a main body right plate and a staple guiding groove;

the main body left plate and the main body right plate are each provided with an inclined surface for cooperating with the shift lever; and

the staple guiding groove is fixed inside the main body.

Optionally, the staple pusher assembly includes a pusher, a spring, a magazine shaft and a pressing member;

the spring has one end connected to the pusher and the other end connected to the pressing member;

the magazine shaft is fixedly connected to the pressing member; and

the pusher is slidably connected to the magazine shaft.

Optionally, the base further includes an elastic member; and

the elastic member has one end connected to the bottom plate and the other end connected to the main body, and is configured to keep a distance between the main body and the base when the staple-ejecting type stapler is in a non-operating state.

Optionally, the small hole on the shift lever is a small oval-shaped hole.

Optionally, an inclined angle of the inclined surface is ranged from 43° to 47° by defining a plane where a bottom surface of the main body is located in as a horizontal plane.

Optionally, the elastic member is a spring.

Optionally, the elastic member is a leaf spring.

As can be seen from the above technical solution, the embodiment of the present application has the following advantages. Compared with the prior art, in the staple-ejecting type stapler according to the present application, the energy storing and energy releasing assembly is arranged inside the main body and is consisted of the leaf spring, the shift lever 05, the staple driver and the reset torsion spring. In using, the top plate is pressed by hand which applies a downward pressure on the top plate. The top plate exerts a downward pressure on the reset torsion spring by means of the lever principle to move the reset torsion spring downwards, so as to rotate the shift lever. During the rotating process, the shift lever drives the staple driver at the other end of the shift lever to move upwards along the guiding groove, and when the end of the shift lever that is connected to the staple driver is moved to a top end of the inclined surface, the energy storing process of the leaf spring is completed. As the top plate continues to move downwards, the shift lever and the staple driver are pressed by the top end of the inclined surface and thus are disengaged, and at this time, the leaf spring releases the stored elastic potential energy to drive the staple driver to move downwards. The staple is pushed by the staple driver to pierce through the paper, and legs of the staple are bent by the anvil plate, thereby completing the whole binding process. The leaf spring may store energy by pressing the top plate with hand by means of the lever principle, thus the binding operation may be completed easily without a large pressure.

### BRIEF DESCRIPTION OF THE DRAWINGS

FIG. 1 is an exploded structural view of a staple-ejecting type stapler according to an embodiment of the present application;

FIG. 2 is a structural view of the staple-ejecting type stapler according to the embodiment of the present application in a non-operating state;

FIG. 3 is a structural view of the staple-ejecting type stapler according to the embodiment of the present application in an operating state; and

FIG. 4 is a structural view showing a magazine left plate and a magazine right plate of the staple-ejecting type stapler according to the embodiment of the present application.

Reference Numerals in the drawings:

| | | | | | |
|---|---|---|---|---|---|
| 01 | top plate, | 02 | main body left | 03 | main body right |
| | | | plate, | | plate, |
| 04 | staple driver, | 05 | shift lever, | 06 | reset torsion spring, |
| 07 | leaf spring, | 08 | staple guiding | 09 | pusher, |
| | | | groove, | | |
| 10 | spring, | 11 | magazine shaft, | 12 | pressing member, |
| 13 | bottom plate, | 14 | anvil plate, and | 15 | elastic member. |

### DETAILED DESCRIPTION

An embodiment of the present application provides a staple-ejecting type stapler, which can use an energy storing and energy releasing assembly to store energy by means of the lever principle and to generate an elastic force by releasing the elastic potential energy. Under the action of the elastic force, a staple driver pushes a staple to pierce through paper, and legs of the staple are bent by an anvil plate, thereby realizing the binding function in a convenient and labor-saving manner.

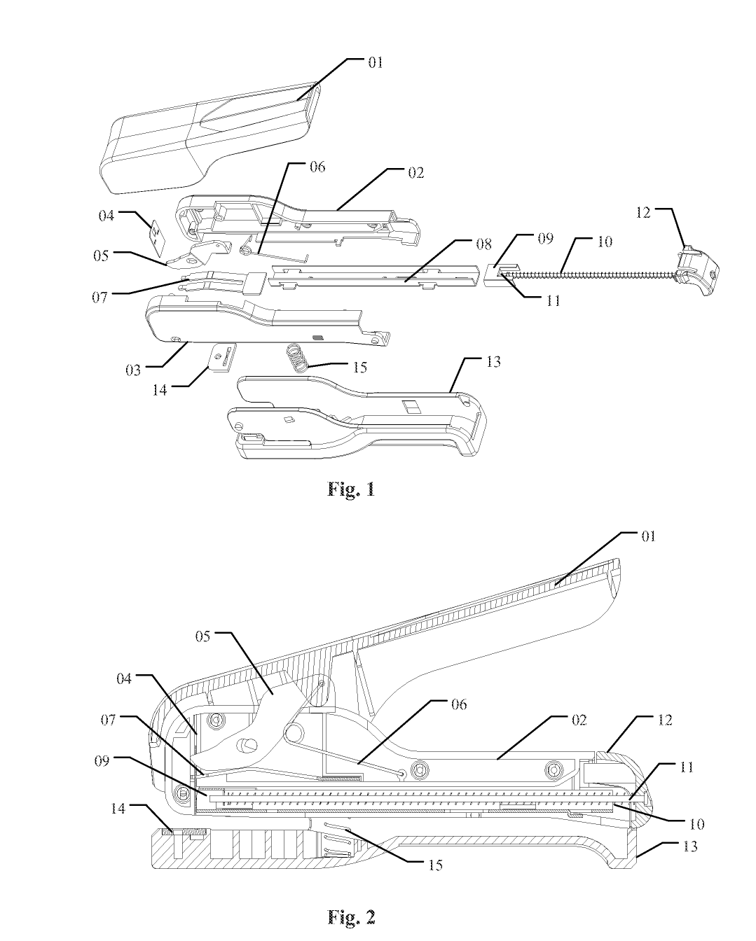

Referring to FIG. 1, the staple-ejecting type stapler according to an embodiment of the present application includes a top plate 01, a main body and a base; the top plate 01 is movably connected to the main body via a rotating shaft and configured to provide pressure for the main body, the main body has two ends, respectively, movably connected to the top plate 01 and the base via a rotating shaft, and the base is provided to support the main body and bend legs of a staple.

The main body includes an energy storing and energy releasing assembly, a staple magazine assembly and a staple pusher assembly. The energy storing and energy releasing assembly is arranged in the main body and is connected to the top plate, and is provided for storing and releasing an elastic potential energy. The staple magazine assembly is provided to receive staples, and the staple pusher assembly is provided to push a staple.

The base includes a bottom plate 13, and an anvil plate 14 fixed on the bottom plate 13 and arranged opposite to a staple outlet.

Optionally, the energy storing and energy releasing assembly includes a staple driver 04, a shift lever 05, a reset torsion spring 06 and a leaf spring 07.

The staple driver 04 is arranged in a guiding groove which is arranged in the main body and is perpendicular to the main body, and the staple driver 04 has an upper portion provided with a small hole for cooperating with one end of the shift lever 05 and a middle portion provided with a small hole for cooperating with the leaf spring 07.

The shift lever 05 is movably arranged inside the main body via a rotating shaft, and is provided with a small hole for cooperating with the rotating shaft and having an area lager than a cross-sectional area of the rotating shaft.

The reset torsion spring 06 has one end connected to one end of the s ever 05 and the top plate 01, and the other end connected to the main body.

The leaf spring 07 has one end connected to the staple driver and the other end fixed on the main body.

Optionally, the staple magazine assembly includes a main body left plate 02, a main body right plate 03 and a staple guiding groove 08;

the main body left plate 02 and the main body right plate 03 are each provided with an inclined surface for cooperating with the shift lever 05; and

the staple guiding groove 08 is fixed inside the main body.

Optionally, the staple pusher assembly includes a pusher 09, a spring 10, a magazine shaft 11 and a pressing member 12;

the spring 10 has one end connected to the pusher 09 and the other end connected to the pressing member 12;

the magazine shaft is fixedly connected to the pressing member 12; and

the pusher 09 is slidably connected to the magazine shaft 11.

In the staple-ejecting type stapler according to the embodiment of the present application, the energy storing and energy releasing assembly is arranged inside the main body and is consisted of the leaf spring 07, the shift lever 05, the staple driver 04 and the reset torsion spring. Referring to FIG. 2, when the staple-ejecting type stapler is in a non-operating state, the leaf spring may be in a natural straight state or in a curved state, i.e. having a certain amount of initial elastic potential energy, according to the requirement of design. In this embodiment of the present application, the leaf spring has a certain amount of initial elastic potential energy, and the staple driver is located at a lower end of the guiding groove of the main body under the action of the leaf spring.

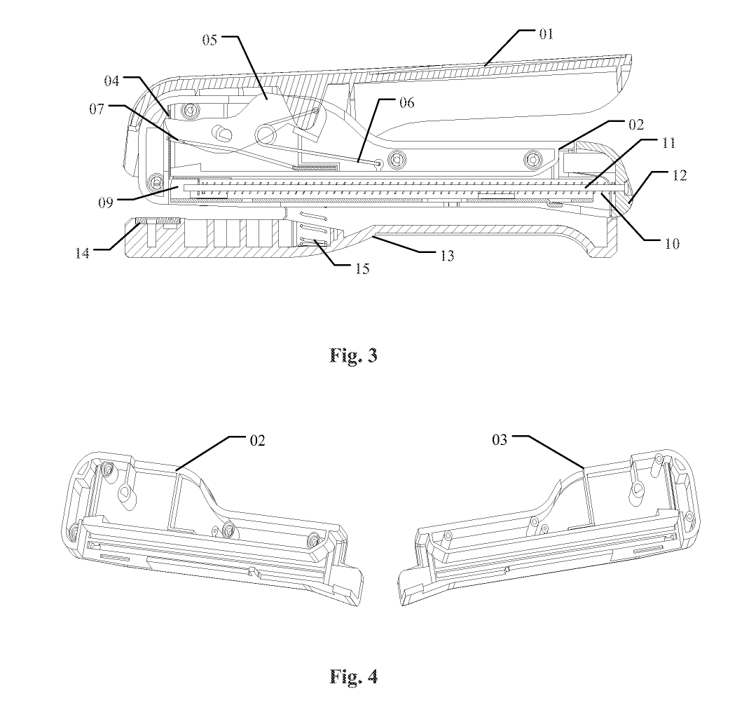

Referring to FIG. 3, when the staple-ejecting type stapler is required to work, the top plate 01 is pressed by hand which applies a downward pressure on the top plate 01. The top plate 01 exerts a downward pressure on the reset torsion spring 06 by means of the lever principle to move the reset torsion spring 06 downwards, so as to rotate the shift lever 05. During the rotating process, the shift lever 05 drives the staple driver 04 at the other end of the shift lever 05 to move upwards along the guiding groove, and when the end of the shift lever 05 that is connected to the staple driver 04 is moved to a top end of the inclined surface, the energy storing process of the leaf spring 07 is completed. As the top plate 01 continues to move downwards, the shift lever 05 and the staple driver 04 are pressed by the top end of the inclined surface and thus are disengaged, and at this time, the leaf spring 07 releases the stored elastic potential energy to drive the staple driver 04 to move downwards. The staple is pushed by the staple driver 04 to pierce through the paper, and legs of the staple are bent by the anvil plate 14, thereby completing the whole binding process.

Optionally, the base further includes an elastic member 15;

the elastic member 15 has one end connected to the bottom plate 13 and the other end connected to the main body, and is configured to keep a certain distance between the main body and the base when the staple-ejecting type stapler is in the non-operating state.

Optionally, by defining a plane where a bottom surface of the main body is located in as a horizontal plane, an inclined angle of the inclined surface is ranged from 43° to 47°, and is preferably 45°.

Optionally, the hole on the shift lever 05 is an oval-shaped hole.

Optionally, the elastic member 15 is a spring.

Optionally, the elastic member 15 is a leaf spring.

Referring to FIG. 4, the function of the inclined surface and the oval-shaped small hole is described below. When the elastic potential energy of the leaf spring reaches the maximum value, the shift lever 05 is disengaged from the staple driver 04, and the leaf spring 07 can smoothly release the elastic potential energy, thereby completing the whole binding process. The small hole on the shift lever 05 is not limited to the oval-shaped hole in this embodiment, and may be small hole in other shapes, as long as the shift lever 05 is able to move forwards and rearwards along the rotation shaft. Regarding the forward and rearward movement of the shift lever 05, the position of the staple driver is defined as the forward direction and the position of the pressing member is defined as the rearward direction.

The elastic member is configured to keep a certain distance between the main body and the base when the staple-ejecting type stapler is in the non-operating state. The elastic member is not limited to the spring shown in Figures of the present application, is not limited to the leaf spring, and can be made of other materials having the same characteristic.

As can be seen from the above technical solution, the embodiment of the present application has the following advantages. Compared with the prior art, in the staple-ejecting type stapler according to the present application, the energy storing and energy releasing assembly is arranged inside the main body and is consisted of the leaf spring 07, the shift lever 05, the staple driver 04 and the reset torsion spring. In using, the top plate 01 is pressed by hand which applies a downward pressure on the top plate 01. The top plate 01 exerts a downward pressure on the reset torsion spring 06 by means of the lever principle to move the reset torsion spring 06 downwards, so as to rotate the shift lever 05. During the rotating process, the shift lever 05 drives the staple driver 04 at the other end of the shift lever 05 to move upwards along the guiding groove, and when the end of the shift lever 05 that is connected to the staple driver 04 is moved to a top end of the inclined surface, the energy storing process of the leaf spring 07 is completed. As the top plate 01 continues to move downwards, the shift lever 05 and the staple driver 04 are pressed by the top end of the inclined surface and thus are disengaged, and at this time, the leaf spring 07 releases the stored elastic potential energy to drive the staple driver 04 to move downwards. The staple is pushed by the staple driver 04 to pierce through the paper, and legs of the staple are bent by the anvil plate 14, thereby completing the whole binding process. The leaf spring 07 may store energy by pressing the top plate 01 with hand by means of the lever principle, thus the binding operation may be completed easily without a large pressure.

The staple-ejecting type stapler according to the present application is described in details hereinbefore. For those skilled in the art, modifications may be made to specific embodiments and application scopes based on the spirit of the present application. In conclusion, the content of the specification should not be interpreted as limitation to the present application.

1. A staple-ejecting type stapler, comprising a top plate, a main body and a base, wherein
the top plate is movably connected to the main body via a rotating shaft and configured to provide pressure for the main body;
the main body has two ends, respectively, movably connected to the top plate and the base via a rotating shaft;
the base is configured to support the main body and bend legs of a staple;
wherein the main body comprises an energy storing and energy releasing assembly, a staple magazine assembly and a staple pusher assembly, the energy storing and energy releasing assembly is arranged in the main body and is connected to the top plate, and is configured to store and release an elastic potential energy, the staple magazine assembly is configured to receive staples, and the staple pusher assembly is configured to push the staples; and
the base comprises a bottom plate and an anvil plate fixed on the bottom plate and arranged opposite to a staple outlet.

2. The staple-ejecting type stapler according to claim 1, wherein the energy storing and energy releasing assembly comprises a staple driver, a shift lever, a reset torsion spring and a leaf spring;
the staple driver is arranged in a guiding groove which is arranged in the main body and is perpendicular to the main body, and the staple driver has an upper portion provided with a small hole for cooperating with one end of the shift lever and a middle portion provided with a small hole for cooperating with the leaf spring;
the shift lever is movably arranged inside the main body via a rotating shaft, and is provided with a small hole for cooperating with the rotating shaft and having an area lager than a cross-sectional area of the rotating shaft;
the reset torsion spring has one end connected to one end of the shift lever and the top plate, and the other end connected to the main body; and
the leaf spring has one end connected to the staple driver and the other end fixed on the main body.

3. The staple-ejecting type stapler according to claim 1, wherein the staple magazine assembly comprises a main body left plate, a main body right plate and a staple guiding groove;
the main body left plate and the main body right plate are each provided with an inclined surface for cooperating with the shift lever; and
the staple guiding groove is fixed inside the main body.

4. The staple-ejecting type stapler according to claim 1, wherein the staple pusher assembly comprises a pusher, a spring, a magazine shaft and a pressing member;
the spring has one end connected to the pusher and the other end connected to the pressing member;
the magazine shaft is fixedly connected to the pressing member; and
the pusher is slidably connected to the magazine shaft.

5. The staple-ejecting type stapler according to claim 1, wherein the base further comprises an elastic member; and
the elastic member has one end connected to the bottom plate and the other end connected to the main body, and is configured to keep a distance between the main body and the base when the staple-ejecting type stapler is in a non-operating state.

6. The staple-ejecting type stapler according to claim 2, wherein the base further comprises an elastic member; and
the elastic member has one end connected to the bottom plate and the other end connected to the main body, and is configured to keep a distance between the main body and the base when the staple-ejecting type stapler is in a non-operating state.

7. The staple-ejecting type stapler according to claim 3, wherein the base further comprises an elastic member; and
the elastic member has one end connected to the bottom plate and the other end connected to the main body, and is configured to keep a distance between the main body and the base when the staple-ejecting type stapler is in a non-operating state.

8. The staple-ejecting type stapler according to claim 4, wherein the base further comprises an elastic member; and
the elastic member has one end connected to the bottom plate and the other end connected to the main body, and is configured to keep a distance between the main body and the base when the staple-ejecting type stapler is in a non-operating state.

9. The staple-ejecting type stapler according to claim 2, wherein the small hole on the shift lever is a small oval-shaped hole.

10. The staple-ejecting type stapler according to claim 3, wherein an inclined angle of the inclined surface is ranged from 43° to 47° by defining a plane where a bottom surface of the main body is located in as a horizontal plane.

11. The staple-ejecting type stapler according to claim 5, wherein the elastic member is a spring.

12. The staple-ejecting type stapler according to claim 5, wherein the elastic member is a leaf spring.
